(19) United States
(12) Patent Application Publication
(10) Pub. No.: US 2024/0095955 A1
(43) Pub. Date: Mar. 21, 2024

(54) CALIBRATION METHOD, CALIBRATION APPARATUS, CALIBRATION SYSTEM, AND RECORDING MEDIUM

(71) Applicant: NEC Corporation, Minato-ku, Tokyo (JP)

(72) Inventors: Shizuo SAKAMOTO, Tokyo (JP); Kouki Miyamoto, Tokyo (JP)

(73) Assignee: NEC Corporation, Minato-ku, Tokyo (JP)

(21) Appl. No.: 18/038,279

(22) PCT Filed: Oct. 20, 2021
(86) PCT No.: PCT/JP2021/038807

§ 371 Date: May 23, 2023

(30) Foreign Application Priority Data
Nov. 30, 2020 (JP) 2020-198243

(51) Int. Cl. G06T 7/80; H04N 23/60

(52) U.S. Cl. CPC G06T 7/80; H04N 23/60

(57) ABSTRACT

A calibration method includes: imaging a member having a predetermined design in which a pattern varies depending on a position on a member surface and a marker disposed at a predetermined position, with at least two cameras; and performing calibration of the at least two cameras by using an image of the member captured by the at least two cameras. According to this calibration method, it is possible to reduce a “deviation” that occurs in a plurality of cameras in a relatively easy manner.

### TECHNICAL FIELD

This disclosure relates to a calibration method, a calibration apparatus, and a calibration system that calibrate a camera, and a recording medium.

### BACKGROUND ART

A known method of calibrating a camera uses a member for calibration, which is imaged by the camera. For example, Patent Literature 1 discloses that a target including a Aruco marker is imaged to calibrate a camera. Patent Literature 2 discloses that multiple installed calibration boards are imaged to estimate a position and an attitude of a camera and to perform calibration. Patent Literature 3 discloses that a calibration board having known geometric and optical characteristics is imaged to calibrate a camera. Patent Literature 4 discloses that a square lattice of a flat plate is imaged while shifting a position of a carriage on which the camera is mounted, thereby to perform calibration.

### CITATION LIST

### Patent Literature

Patent Literature 1: JP2019-530261A
Patent Literature 2: JP2017-103602A
Patent Literature 3: JP2004-192378A
Patent Literature 4: JPH10-320558A

### SUMMARY

### Technical Problem

This disclosure aims to improve the related technique/technology described above.

### Solution to Problem

A calibration method according to an example aspect of this disclosure includes: imaging a member having a predetermined design in which a pattern varies depending on a position on a member surface and a marker disposed at a predetermined position, with at least two cameras; and performing calibration of the at least two cameras by using an image of the member captured by the at least two cameras.

A calibration apparatus according to an example aspect of this disclosure includes: an acquisition unit that obtains an image captured by imaging a member having a predetermined design in which a pattern varies depending on a position on a member surface and a marker disposed at a predetermined position, with at least two cameras; and a calibration unit that performs calibration of the at least two cameras by using the image of the member captured by the at least two cameras.

A calibration system according to an example aspect of this disclosure includes: a member having a predetermined design in which a pattern varies depending on a position on a member surface and a marker disposed at a predetermined position; a drive apparatus that drives the member to change a position or angle of the member with respect to at least two cameras; and a calibration apparatus that performs calibration of the at least two cameras by using an image of the member imaged by the at least two cameras.

A recording medium according to an example aspect of this disclosure is a recording medium on which a computer program is recorded, the computer program operating a computer: to image a member having a predetermined design in which a pattern varies depending on a position on a member surface and a marker disposed at a predetermined position, with at least two cameras; and to perform calibration of the at least two cameras by using an image of the member captured by the at least two cameras.

### BRIEF DESCRIPTION OF DRAWINGS

FIG. 1 is a schematic configuration diagram illustrating a calibration member and cameras for performing calibration by a calibration method according to a first example embodiment.

FIG. 2 is a plan view illustrating a configuration of a calibration member used in the calibration method according to the first example embodiment.

FIG. 3 is a flowchart illustrating a flow of operation of the calibration method according to the first example embodiment.

FIG. 4 is a flowchart illustrating a flow of operation of a calibration method according to a second example embodiment.

FIG. 5 is a flowchart illustrating a flow of operation of a calibration method according to a modified example of the second example embodiment.

FIG. 6 is a flowchart illustrating a flow of operation of a calibration method according to a third example embodiment.

FIG. 7 is a flowchart illustrating a flow of operation of a calibration method according to a fourth example embodiment.

FIG. 8 is a diagram illustrating an example of changing a position of the calibration member in the calibration method according to the fourth example embodiment.

FIG. 9 is a diagram illustrating an example of changing an angle of the calibration member in the calibration method according to the fourth example embodiment.

FIG. 10 is a flowchart illustrating a flow of operation of a calibration method according to a fifth example embodiment.

FIG. 11 is a flowchart illustrating a flow of operation of a calibration method according to a modified example of the fifth example embodiment.

FIG. 12 is a diagram (version 1) illustrating an example of an output aspect of outputting a guidance information by a calibration apparatus according to the fifth example embodiment.

FIG. 13 is a diagram (version 2) illustrating an example of the output aspect of outputting the guidance information by the calibration apparatus according to the fifth example embodiment.

FIG. 14 is a block diagram illustrating a hardware configuration of a calibration apparatus according to an eighth example embodiment.

FIG. 15 is a block diagram illustrating a functional configuration of the calibration apparatus according to the eighth example embodiment.

FIG. 16 is a flowchart illustrating a flow of operation of the calibration apparatus according to the eighth example embodiment.

FIG. 17 is a block diagram illustrating a functional configuration of a calibration system according to a ninth example embodiment.

FIG. 18 is a flowchart illustrating a flow of operation of a drive apparatus of the calibration system according to the ninth example embodiment.

FIG. 19 is a flowchart illustrating a flow of operation of calibration using three-dimensional images.

### DESCRIPTION OF EXAMPLE EMBODIMENTS

Hereinafter, a calibration method, a calibration apparatus, a calibration system, a computer program, and a recording medium according to example embodiments will be described with reference to the drawings.

### First Example Embodiment

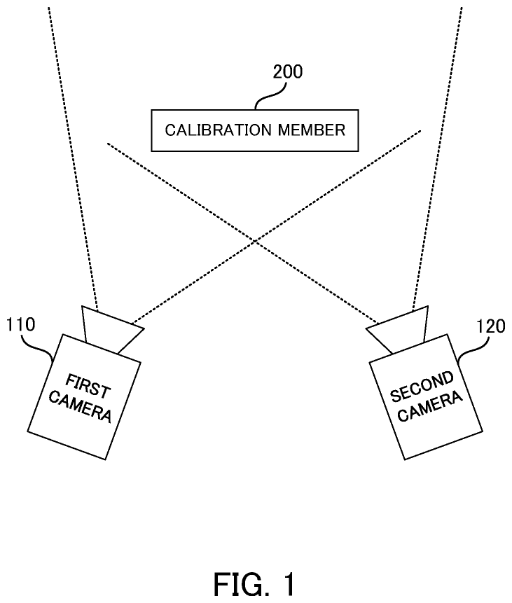

A calibration method according to a first example embodiment will be described with reference to FIG. 1 to FIG. 3.

### (Configuration of Cameras)

First, a configuration of cameras that are targets of the calibration method according to the first example embodiment will be described with reference to FIG. 1. FIG. 1 is a schematic configuration diagram illustrating a calibration member and cameras for performing calibration by the calibration method according to the first example embodiment.

As illustrated in FIG. 1, in the calibration method according to the first example embodiment, a first camera 110 and a second camera 120 are calibrated. The first camera 110 and the second camera 120 are arranged to image a same subject from different angles, for example. The first camera 110 and the second camera 120, however, may be arranged to image a subject from the same angle. The first camera 110 and the second camera 120 may include a solid-state imaging device, such as, for example, a CCD (Charge Coupled Device) image sensor and a CMOS (Complementary Metal Oxide Semiconductor) image sensor. The first camera 110 and the second camera 120 may include an optical system for forming an image of the subject on an imaging surface of the solid-state imaging device, a signal processing circuit for signal-processing an output of the solid-state imaging device and obtaining a luminance value for each pixel, or the like.

In the calibration method according to the first example embodiment, a common calibration member 200 is imaged by the first camera 110 and the second camera 120. The calibration member 200 is, for example, a plate-shaped member, and is configured to be held and usable in a human hand. The calibration member 200 may be configured to be available by being placed in a predetermined place or being attached to a support member. In performing the calibration method according to the first example embodiment, a user who holds the calibration member 200 in the hand may move to be in an imaging range of the first camera 110 and the second camera 120. Alternatively, the calibration member 200 may be used in a condition of being fixed to a predetermined support member. In this case, the calibration member 200 may be disposed in the imaging range of the first camera 110 and the second camera 120 by the user moving the support member to which it is fixed. Alternatively, the calibration member 200 may be used in a condition of being drivable by a predetermined drive apparatus. In this case, the calibration member 200 may be disposed in the imaging range of the first camera 110 and the second camera 120 by being driven (e.g., changed in position and angle) by the drive apparatus. A more specific configuration of the calibration member 200 will be described in detail below.

### (Configuration of Calibration Member)

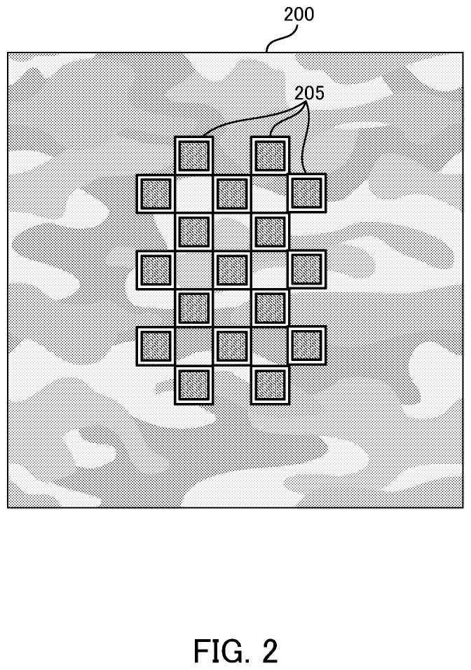

Next, a configuration of the calibration member 200 used in the calibration method according to the first example embodiment will be specifically described with reference to FIG. 2. FIG. 2 is a plan view illustrating the configuration of the calibration member used in the calibration method according to the first example embodiment.

As illustrated in FIG. 2, the calibration member 200 used in the calibration method according to the first example embodiment has a predetermined design. The “predetermined design” here is a design in which a pattern varies depending on a position on a member surface. More specifically, the predetermined design may be a design in which what part of the calibration member 200 is captured, or at what angle or in which direction the calibration member 200 is captured (e.g., when it is upside down, etc.), can be determined from the pattern in the captured image. An example of the predetermined design may be, but not limited to, a camouflage pattern as illustrated in FIG. 2. When the calibration member 200 of the camouflage pattern is used, the first camera 110 and the second camera 120 are preferably configured as cameras that are capable of performing shape measurement (e.g., a 3D scanner or a range finder, etc.). That is, it is desirable to perform the 3D shape measurement with the first camera 110 and the second camera 120 and to perform calibration in accordance with the result. Such calibration will be described in detail in another example embodiment described later.

The calibration member 200 further includes a marker 205. The marker 205 is disposed at a predetermined position of the calibration member 200. The marker 205 may be disposed to be superimposed on the predetermined design of the calibration member 200, for example. A plurality of markers 205 may be arranged in the calibration member 200. In this case, an arrangement position of the plurality of markers 205 may be a predetermined arrangement as illustrated in FIG. 2, for example.

The arrangement of the plurality of markers 205 illustrated in FIG. 2 is an example, and the number and arrangement pattern of the plurality of markers 205 are not particularly limited. In the example illustrated in FIG. 2, the plurality of markers 205 are arranged to be densely gathered near the center of the calibration member 200, but may be arranged evenly throughout the calibration member 200. Alternatively, the plurality of markers 205 may be disposed only at particular positions of the calibration member 200 (e.g., at four corners of the calibration member 200, etc.).

On the other hand, only a single marker 205 may be disposed in the calibration member 200. In this case, it is preferable that the marker 205 is capable of specifying not only its position but also its direction. That is, which part of the calibration member is imaged, and in which direction the calibration member is imaged, can be estimated, preferably only by detecting a single marker 205 from the captured image.

The calibration member 200 is typically configured as a planar member, but may be a member having at least a partially curved surface. When a shape of the subject of the first camera 110 and the second camera 120 (i.e., a target to be imaged in an operation after the calibration) is known, the calibration member 200 may have a shape corresponding to the shape of the subject. For example, when the subject of the first camera 110 and the second camera 120 is a “face of a person”, the calibration member 200 may be configured to have a shape close to the face of the person as a member. Furthermore, the calibration member 200 may be a member with convexity and concavity. The convexity and concavity in this case may be uniformly present on the calibration member 200, or may be present only at a particular position. For example, as described above, when the subject of the first camera 110 and the second camera 120 is the “face of a person”, the convexity and concavity corresponding to eyes, a nose, ears, a mouth, and the like of the person may be provided. Alternatively, the convexity and concavity corresponding to the predetermined design of the calibration member 200 may be provided.

The calibration member 200 may have a honeycomb structure to achieve weight reduction and increase rigidity. For example, the calibration member 200 may be configured as an aluminum honeycomb board. A material that constitutes the calibration member 200, however, is not particularly limited.

### (Flow of Operation)

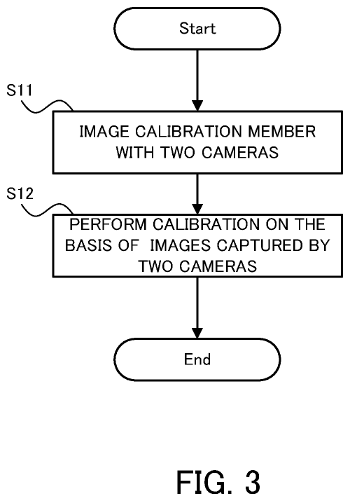

Next, a flow of operation of the calibration method according to the first example embodiment will be described with reference to FIG. 3. FIG. 3 is a flowchart illustrating the flow of the operation of the calibration method according to the first example embodiment.

As illustrated in FIG. 3, in the calibration method according to the first example embodiment, first, the first camera 110 and the second camera 120 respectively capture images of the calibration member 200 (step S11). Imaging by the first camera 110 and imaging by the second camera 120 are preferably performed at as close timing as possible (preferably at the same time). The images captured by the first camera 110 and the second camera 120 may include the entire calibration member 200, or may include only a part of the calibration member 200. When the images including only a part of the calibration member 200 are captured, the calibration member 200 may be disposed at a position at which a common part of the calibration member 200 is imaged by the first camera 110 and the second camera 120.

Subsequently, the first camera 110 and the second camera 120 are calibrated on the basis of the images of the calibration member 200 captured by the first camera 110 and the second camera 120 (more specifically, a set of an image captured by the first camera 110 and an image captured by the second camera 120) (step S12). Specifically, the calibration is performed by using the predetermined design and the marker 205 of the calibration member 200. The calibration using the predetermined design of the calibration member 200 and the calibration using the marker 205 of the calibration member 200 will be described in detail in another example embodiment described later.

A technique of the calibration is not particularly limited, but it may be changing parameters of the first camera 110 and the second camera 120 on the basis of a “deviation” estimated from the captured images of the first camera 110 and the second camera 120, for example. For example, software may be used to control the focal point and angle of the first camera 110 and the second camera 120.

### (Technical Effect)

Next, a technical effect obtained by the calibration method according to the first example embodiment will be described.

As described in FIG. 1 to FIG. 3, in the calibration method according to the first example embodiment, the images of the calibration member 200 having the predetermined design and the marker 205 are captured, thereby to calibrate the first camera 110 and the second camera 120 (i.e., at least two cameras). In this way, by using the predetermined design and the marker 205 of the calibration member 200, it is possible to effectively reduce the “deviation” that occurs in the plurality of cameras, in a relatively easy manner.

### Second Example Embodiment

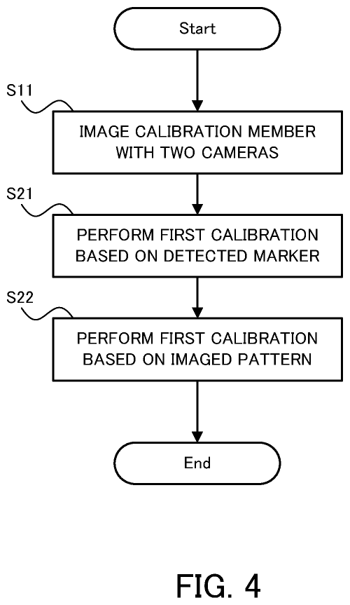

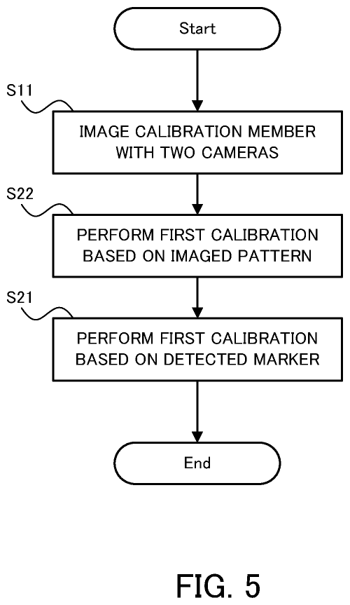

A calibration method according to a second example embodiment will be described with reference to FIG. 4 and FIG. 5. The second example embodiment is partially different from the first example embodiment only in the operation, and may be the same as the first example embodiment in the configurations of the first camera 110, the second camera 120, and the calibration member 200 (see FIGS. 1 and 2) and the like, for example. For this reason, a part that is different from the first example embodiment will be described in detail below, and a description of the other overlapping parts will be omitted as appropriate.

### (Flow of Operation)

First, a flow of operation of the calibration method according to the second example embodiment will be described with reference to FIG. 4. FIG. 4 is a flowchart illustrating the flow of the operation of the calibration method according to the second example embodiment. In FIG. 4, the same steps as those illustrated in FIG. 3 carry the same reference numerals.

As illustrated in FIG. 4, in the calibration method according to the second example embodiment, first, the first camera 110 and the second camera 120 respectively capture images of the calibration member 200 (step S11).

Especially in the second example embodiment, a first calibration process based on the marker 205 in the images captured by the first camera 110 and the second camera 120 is performed (step S21). In the first calibration process, the marker 205 is detected from the captured images, and the calibration based on the detected marker is performed. When a plurality of markers 205 are detected from the captured images, each of the plurality of markers 205 (i.e., all the detected markers 205) may be used for the calibration. Alternatively, only a part of the detected markers 205 may be used for the calibration. The first calibration process may be a process of detecting a position deviation that occurs between the first camera 110 and the second camera 120 on the basis of the position of the marker 205 in the images and of making an adjustment to reduce the deviation, for example. Alternatively, the first calibration process may be a process of detecting a direction deviation that occurs between the first camera 110 and the second camera 120 on the basis of the direction of the marker 205 in the images and of making an adjustment to reduce the deviation, for example. The first calibration process may be a calibration process that is less accurate (in other words, rougher) than a second calibration process described later.

After the first calibration process, a second calibration process based on a pattern of the predetermined design in the images captured by the first camera 110 and the second camera 120 is performed (step S22). In the second calibration process, which part of the calibration member 200 is captured, is estimated from the pattern in the captured images, and the calibration is performed depending on which part is captured. The second calibration process may be a process of detecting the position deviation that occurs between the first camera 110 and the second camera 120 on the basis of the pattern of the predetermined design in the images (specifically, an imaging position of the calibration member 200 estimated from the pattern) and of making an adjustment to reduce the deviation, for example. Alternatively, the second calibration process may be a process of detecting the direction deviation that occurs between the first camera 110 and the second camera 120 on the basis of the pattern of the predetermined design in the images (specifically, an imaging direction of the calibration member 200 estimated from the pattern) and of making an adjustment to reduce the deviation. The second calibration process may be a calibration process that is more accurate (in other words, finer) than the first calibration process.

### Modified Example

Next, a flow of operation of a calibration method according to a modified example of the second example embodiment will be described with reference to FIG. 5. FIG. 5 is a flowchart illustrating the flow of the operation of the calibration method according to the modified example of the second example embodiment. In FIG. 5, the same steps as those illustrated in FIG. 4 carry the same reference numerals.

As illustrated in FIG. 5, in the calibration method according to the modified example of the second example embodiment, first, the first camera 110 and the second camera 120 respectively capture images of the calibration member 200 (step S11).

Especially in the modified example embodiment, the second calibration process based on the pattern of the predetermined design in the images captured by the first camera 110 and the second camera 120 is performed (step S22). In the second calibration process, as in the case described in FIG. 4, which part of the calibration member 200 is imaged, is estimated from the pattern in the captured images, and the calibration is performed depending on which part is imaged. The second calibration process may be a process of detecting the position deviation that occurs between the first camera 110 and the second camera 120 on the basis of the pattern of the predetermined design in the images (specifically, the imaging position of the calibration member 200 estimated from the pattern) and of making an adjustment to reduce the deviation, for example. Alternatively, the second calibration process may be a process of detecting the direction deviation that occurs between the first camera 110 and the second camera 120 on the basis of the pattern of the predetermined design in the images (specifically, the imaging direction of the calibration member 200 estimated from the pattern) and of making an adjustment to reduce the deviation, for example. The second calibration process according to the modified example may be a calibration process that is less accurate (in other words, rougher) than the first calibration process according to the modified example described later.

After the second calibration process, the first calibration process based on the marker 205 in the images captured by the first camera 110 and the second camera 120 is performed (step S21). In the first calibration process, as in the case described in FIG. 4, the marker 205 is detected from the captured images, and the calibration based on the detected marker is performed. When a plurality of markers 205 are detected from the captured images, each of the plurality of markers 205 (i.e., all the detected markers 205) may be used for the calibration. Alternatively, only a part of the detected markers 205 may be used for the calibration. The first calibration process may be a process of detecting the position deviation that occurs between the first camera 110 and the second camera 120 on the basis of the position of the marker 205 in the images and of making an adjustment to reduce the deviation, for example. Alternatively, the first calibration process may be a process of detecting the direction deviation that occurs between the first camera 110 and the second camera 120 on the basis of the direction of the marker 205 in the images and of making an adjustment to reduce the deviation, for example. The calibration process based on the position of the marker 205 and the calibration process based on the direction of the marker 205 may be performed in combination with each other. That is, a calibration process based on both the position and direction of the marker 205 may be performed. The first calibration process according to the modified example may be a calibration process that is more accurate (in other words, finer) than the second calibration process according to the modified example.

### (Technical Effect)

Next, a technical effect obtained by the calibration method according to the second example embodiment will be described.

As described in FIG. 4 and FIG. 5, in the calibration method according to the second example embodiment, the first calibration process based on the marker 205 of the calibration member 200, and the second calibration process based on the pattern of the predetermined design of the calibration member 200 are sequentially performed. In this way, each of the predetermined design and the marker 205 of the calibration member 200 can be used to perform proper calibration. As already described, by performing rough adjustment in one of the first calibration process and the second calibration process that is previously performed and then performing fine adjustment in the other process that is subsequently performed, it is possible to effectively reduce the deviation between the first camera 110 and the second camera 120 by stepwise calibration.

### Third Example Embodiment

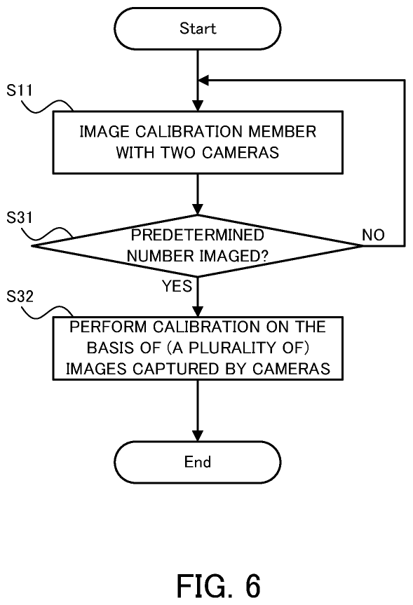

A calibration method according to a third example embodiment will be described with reference to FIG. 6. The third example embodiment is partially different from the first and the second example embodiments only in the operation, and may be the same as the first and the second example embodiments in other parts. For this reason, a part that is different from each of the example embodiments described above will be described in detail below, and a description of the other overlapping parts will be omitted as appropriate.

### (Flow of Operation)

First, a flow of operation of the calibration method according to the third example embodiment will be described with reference to FIG. 6. FIG. 6 is a flowchart illustrating the flow of the operation of the calibration method according to the third example embodiment. In FIG. 6, the same steps as those illustrated in FIG. 3 carry the same reference numerals.

As illustrated in FIG. 6, in the calibration method according to the third example embodiment, first, the first camera 110 and the second camera 120 respectively capture images of the calibration member 200 (step S11).

Especially in the third example embodiment, it is determined whether or not the number of the images captured by the first camera 110 and the second camera 120 reaches a predetermined number (step S31). Here, the “predetermined number” is the number of images required for the calibration using a plurality of images described later, and an appropriate number may be determined by simulation or the like in advance, for example. When the number of the images captured by the first camera 110 and the second camera 120 does not reach the predetermined number (step S31: NO), the step S11 is performed again. That is, the first camera 110 and the second camera 120 respectively capture images of the calibration member 200. As described above, the imaging of the calibration member 200 by the first camera 110 and the second camera 120 is repeatedly performed until the number of the captured images reaches the predetermined number.

On the other hand, when the number of the images captured by the first camera 110 and the second camera 120 reaches the predetermined number (step S31: YES), the first camera 110 and the second camera 120 are calibrated on the basis of the plurality of images of the calibration members 200 captured by the first camera 110 and the second camera 120 (step S32). More specifically, the calibration is performed by using a plurality of sets of the images captured by the first camera 110 and the images captured by the second camera 120. The calibration here may be a process of performing the calibration a plurality of times, by the number of times of imaging that the images are captured. Alternatively, it may be a process of integrating all or a part of the images captured a plurality of times and of performing the calibration a smaller number of times than the number of times of imaging. Alternatively, it may be a process of selecting a part of the images captured a plurality of times and of performing the calibration using only the selected image(s).

The calibration in the step S32 may be performed as the first calibration process and the second calibration process as in the second example embodiment (see FIG. 4 and FIG. 5). Specifically, as the first calibration process, a process of detecting the marker 205 from the images captured a plurality of times and of performing the calibration based on the detected marker, may be performed. Furthermore, as the second calibration process, a process of estimating which part of the calibration member 200 is imaged from the pattern of the images captured a plurality of times and of performing the calibration depending on which part is imaged, may be performed. The first calibration process and the second calibration process may be performed in an arbitrary order.

### (Technical Effect)

Next, a technical effect obtained by the calibration method according to the third example embodiment will be described.

As described in FIG. 6, in the calibration method according to the third example embodiment, the imaging of the calibration member 200 by the first camera 110 and the second camera 120 is performed a plurality of times until the number of the captured images reaches the predetermined number. In this way, the accuracy of the calibration can be improved due to an increase in the number of the images used for the calibration, in comparison with the accuracy when the imaging is performed only once. In addition, even when an image that is not suitable for the calibration is captured, the calibration may be performed by using another image, and it is thus possible to prevent improper calibration from being performed.

### Fourth Example Embodiment

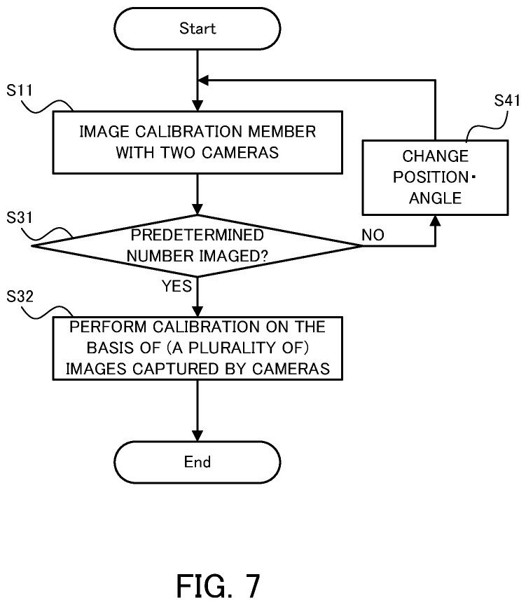

A calibration method according to a fourth example embodiment will be described with reference to FIG. 7 to FIG. 9. The fourth example embodiment is partially different from the third example embodiment only in the operation, and may be the same as the third example embodiment in other parts. For this reason, a part that is different from each of the example embodiments described above will be described in detail below, and a description of the other overlapping parts will be omitted as appropriate.

### (Flow of Operation)

First, a flow of operation of the calibration method according to the fourth example embodiment will be described with reference to FIG. 7. FIG. 7 is a flowchart illustrating the flow of the operation of the calibration method according to the fourth example embodiment. In FIG. 7, the same steps as those illustrated in FIG. 6 carry the same reference numerals.

As illustrated in FIG. 7, in the calibration method according to the fourth example embodiment, first, the first camera 110 and the second camera 120 respectively capture images of the calibration member 200 (step S11).

Subsequently, it is determined whether or not the number of the images captured by the first camera 110 and the second camera 120 reaches the predetermined number (step S31). When the number of the images captured by the first camera 110 and the second camera 120 does not reach the predetermined number (step S31: NO), the step S11 is performed again as in the third example embodiment. Especially in the fourth example embodiment, however, at least one of the position and angle of the calibration member 200 is changed (step S41), and then, the step S11 is performed. Thus, in the second and subsequent imaging, the calibration member 200 is imaged at a different position or angle from before. A method of changing the position and angle of the calibration member 200 will be described in detail with a specific example.

When the number of the images captured by the first camera 110 and the second camera 120 reaches the predetermined number (step S31: YES), the first camera 110 and the second camera 120 are calibrated on the basis of the plurality of images of the calibration members 200 captured by the first camera 110 and the second camera 120 (step S32). More specifically, the calibration is performed by using a plurality of sets of the images captured by the first camera 110 and the images captured by the second camera 120. The calibration here may be a process of performing the calibration a plurality of times, by the number of times of imaging that the images are captured. Alternatively, it may be a process of integrating all or a part of the images captured a plurality of times and of performing the calibration a smaller number of times than the number of times of imaging. Alternatively, it may be a process of selecting a part of the images captured a plurality of times and of performing the calibration using only the selected image(s).

The calibration in the step S32 may be performed as the first calibration process and the second calibration process as in the second example embodiment (see FIG. 4 and FIG. 5). Specifically, as the first calibration process, a process of detecting the marker 205 from the images captured a plurality of times and of performing the calibration based on the detected marker, may be performed. Furthermore, as the second calibration process, a process of estimating which part of the calibration member 200 is imaged from the pattern of the images captured a plurality of times and of performing the calibration depending on which part is imaged, may be performed. The first calibration process and the second calibration process may be performed in an arbitrary order.

### (Change of Position and Angle)

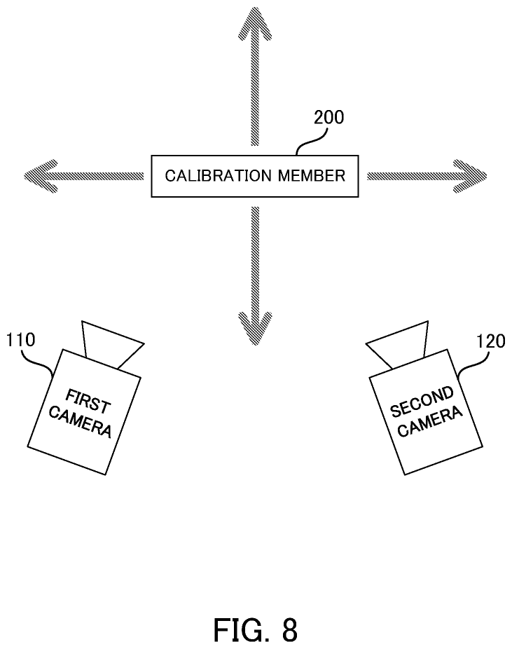

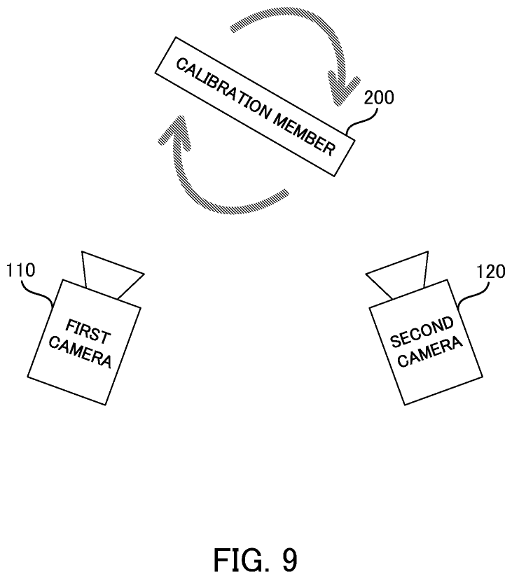

Next, the method of changing the position and angle of the calibration member will be specifically described with reference to FIG. 8 and FIG. 9. FIG. 8 is a diagram illustrating an example of changing the position of the calibration member in the calibration method according to the fourth example embodiment. FIG. 9 is a diagram illustrating an example of changing the angle of the calibration member in the calibration method according to the fourth example embodiment.

As illustrated in FIG. 8, the calibration member 200 may be moved in a longitudinal direction or a lateral direction, by which the position may be changed. Furthermore, the calibration member 200 may be moved in a vertical direction (i.e., a front side and a rear side of the paper surface), by which the position may be changed. In addition, the calibration member 200 may be moved in a diagonal direction that is a combination of the longitudinal direction, the lateral direction, and the vertical direction, by which the position may be changed. An amount of movement of the calibration member 200 may be set in advance. When the calibration member 200 is moved a plurality of times, the amount of movement per time may be the same at each time, or may be changed at each time. For example, the amount of movement may be gradually increased, or the amount of movement may be gradually reduced.

As illustrated in FIG. 9, the calibration member 200 may be rotated, by which the angle may be changed. In the example illustrated in FIG. 9, for convenience of explanation, it is exemplified that the calibration member 200 is rotated clockwise around an axis near the center thereof, but it may be rotated in another aspect. That is, the axis for rotating the calibration member 200 is not particularly limited, and it may be any axis of rotation. Furthermore, there may be two or more axes of rotation for rotating the calibration member 200. In addition, a rotation direction of the calibration member 200 is not limited to a single direction, but it may be rotated in various directions. The axis of rotation and the rotation direction of the calibration member 200 may be set in advance. When the calibration member 200 is rotated a plurality of times, an amount of rotation per time may be the same at each time, or may be changed at each time. For example, the amount of rotation may be gradually increased, or the amount of rotation may be gradually reduced. The rotation direction may be also the same at each time, or may be changed at each time.

The position and angle of the calibration member 200 may be changed manually. When the calibration member 200 is changed manually, a guidance information (i.e., information indicating a distance or a direction in which the calibration member is moved) may be presented to the user. The guidance information will be described in detail in another example embodiment described later. The position and angle of the calibration member 200 may be changed automatically by using a drive apparatus or the like. A configuration including the drive apparatus will be described in detail in another example embodiment described later.

### (Technical Effect)

Next, a technical effect obtained by the calibration method according to the fourth example embodiment will be described.

As described in FIG. 7 to FIG. 9, in the calibration method according to the fourth example embodiment, a plurality of images are captured while the position or angle of the calibration member 200 is changed. In this way, the calibration member 200 is imaged from a different distance or angle, and thus, the accuracy of the calibration can be improved due to an increase in variation of the images of the calibration member 200, in comparison with the accuracy when the imaging is performed only at the same distance or angle. Furthermore, even when images are captured at a distance or angle that is not suitable for the calibration, the calibration may be performed by using another image, and it is thus possible to prevent improper calibration from being performed.

### Fifth Example Embodiment

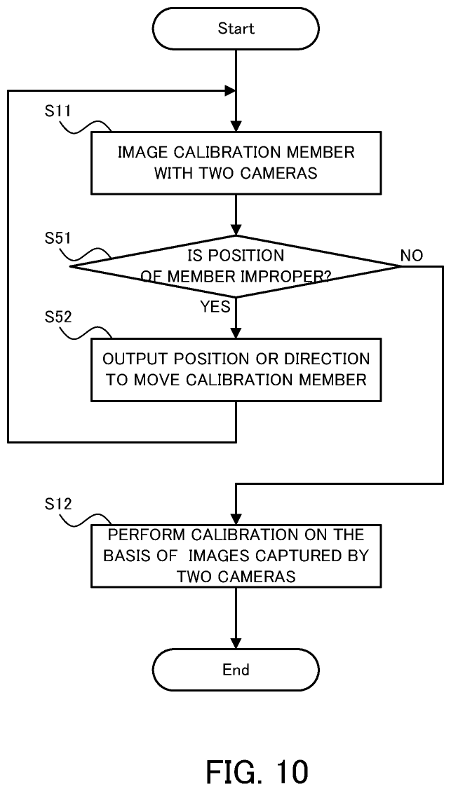

A calibration method according to a fifth example embodiment will be described with reference to FIG. 10 to FIG. 13. The fifth example embodiment is partially different from the first to fourth example embodiments only in the operation, and may be the same as the first to third example embodiments in other parts. For this reason, a part that is different from each of the example embodiments described above will be described in detail below, and a description of the other overlapping parts will be omitted as appropriate.

### (Flow of Operation)

First, a flow of operation of the calibration method according to the fifth example embodiment will be described with reference to FIG. 10. FIG. 10 is a flowchart illustrating the flow of the operation of the calibration method according to the fifth example embodiment. In FIG. 10, the same steps as those illustrated in FIG. 3 carry the same reference numerals.

As illustrated in FIG. 10, in the calibration method according to the fifth example embodiment, first, the first camera 110 and the second camera 120 respectively capture images of the calibration member 200 (step S11).

Especially in the fifth example embodiment, it is determined whether or not the position of the calibration member 200 is improper (step S51). More specifically, it is determined whether or not the calibration member 200 is imaged by the first camera 110 and the second camera 120 at a position or angle that is suitable for performing the calibration. A determination method here is not particularly limited, but it may be determined whether or not the calibration member 200 is in a predetermined range on the basis of the captured images, for example. The “predetermined range” here may be set in advance by simulation or the like in advance.

When the position of the calibration member 200 is improper (step S51: YES), information about the position or direction to move the calibration member (hereinafter referred to as the “guidance information” as appropriate) is outputted (step S52). The guidance information may be, for example, information outputted to the user who has the calibration member 200. In this case, the user may be presented with information indicating how to move the calibration member 200. The user may move the calibration member 200 in accordance with the guidance information. An example of outputting the guidance information to the user will be described in detail later. The guidance information may be information outputted to the drive apparatus that drives the calibration member 200. In this case, information about the amount of movement or a direction of movement of the calibration member 200 or a coordinate information about a movement target point of the calibration member 200 may be outputted to the drive apparatus. The drive apparatus may drive the calibration member 200 in accordance with the guidance information.

After the guidance information is outputted, the step S11 is performed again. That is, the first camera 110 and the second camera 120 respectively capture images of the calibration member 200. Then, it is again determined whether or not the position of the calibration member 200 is improper (step S51). As described above, in the calibration method according to the fifth example embodiment, the capture of images by the first camera 110 and the second camera 120 is repeatedly performed until the position of the calibration member 200 becomes proper.

On the other hand, when the position of the calibration member 200 is not improper (step S51: NO), the first camera 110 and the second camera 120 are calibrated on the basis of the images of the calibration member 200 captured by the first camera 110 and the second camera 120 (step S12). Specifically, the calibration is performed by using the predetermined design and the marker 205 of the calibration member 200.

### Modified Example

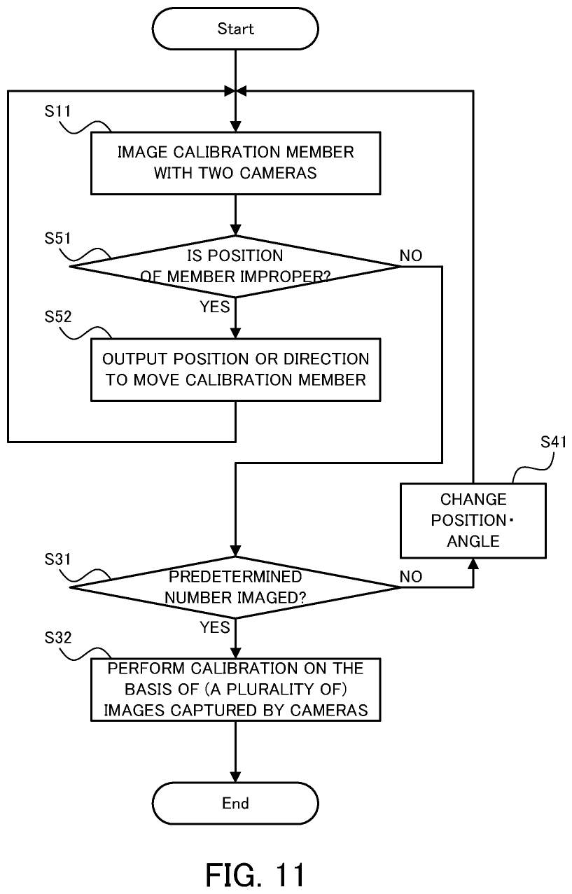

Next, a flow of operation of a calibration method according to a modified example of the fifth example embodiment will be described with reference to FIG. 11. FIG. 11 is a flowchart illustrating the flow of the operation of the modified example of the calibration method according to the fifth example embodiment. In FIG. 11, the same steps as those illustrated in FIG. 7 carry the same reference numerals.

As illustrated in FIG. 11, in the calibration method according to the modified example of the fifth example embodiment, the first camera 110 and the second camera 120 respectively capture images of the calibration member 200 (step S11).

Subsequently, it is determined whether or not the position of the calibration member 200 is improper (step S51). When the position of the calibration member 200 is improper (step S51: YES), the guidance information indicating the position or direction to move the calibration member is outputted (step S52).

After the guidance information is outputted, the step S11 is performed again. That is, the first camera 110 and the second camera 120 respectively capture images of the calibration member 200. Then, it is again determined whether or not the position of the calibration member 200 is improper (step S51). As described above, even in the calibration method according to the modified example of the fifth example embodiment, the capture of images by the first camera 110 and the second camera 120 is repeatedly performed until the position of the calibration member 200 becomes proper.

On the other hand, when the position of the calibration member 200 is not improper (step S51: NO), it is determined whether or not the number of the images captured by the first camera 110 and the second camera 120 reaches the predetermined number (step S31). Then, when the number of the images captured by the first camera 110 and the second camera 120 does not reach the predetermined number (step S31: NO), at least one of the position and angle of the calibration member 200 is changed (step S41), and then, the step S11 is performed. Especially in the modified example of the fifth example embodiment, it is again determined whether or not the position of the calibration member 200 is improper (step S51). When the position of the calibration member 200 is improper (step S51: YES), the guidance information indicating the position or direction to move the calibration member is outputted (step S52).

After the guidance information is outputted, the step S11 is performed again. That is, the first camera 110 and the second camera 120 respectively capture images of the calibration member 200. Then, it is again determined whether or not the position of the calibration member 200 is improper (step S51). As described above, in the calibration method according to the modified example of the fifth example embodiment, even after the position and angle of the calibration member is changed, the capture of images by the first camera 110 and the second camera 120 is repeatedly performed until the position of the calibration member 200 becomes proper.

On the other hand, when the number of the images captured by the first camera 110 and the second camera 120 reaches the predetermined number (step S31: YES), the first camera 110 and the second camera 120 are calibrated on the basis of the plurality of images of the calibration members 200 captured by the first camera 110 and the second camera 120 (step S32). More specifically, the calibration is performed by using a plurality of sets of the images captured by the first camera 110 and the images captured by the second camera 120.

### Specific Examples of Guidance Information

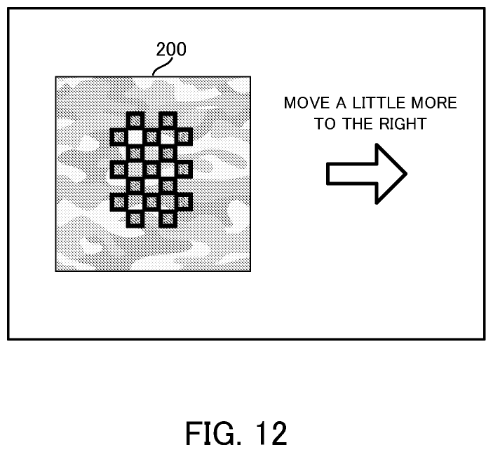

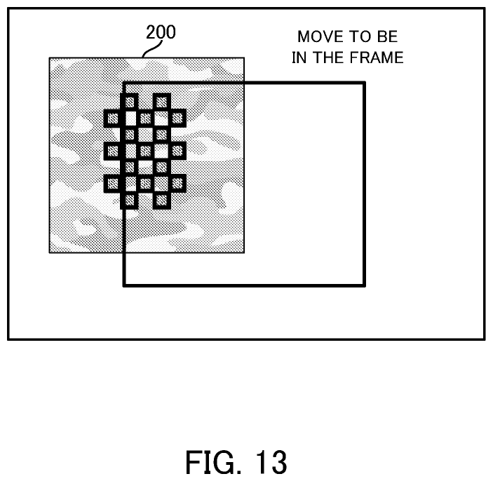

Next, the guidance information outputted by the calibration method according to the fifth example embodiment will be specifically described with reference to FIG. 12 and FIG. 13. FIG. 12 is a diagram (version 1) illustrating an example of an output aspect of outputting the guidance information by the calibration apparatus according to the fifth example embodiment. FIG. 13 is a diagram (version 2) illustrating an example of the output aspect of outputting the guidance information by the calibration apparatus according to the fifth example embodiment.

As illustrated in FIG. 12, the guidance information is presented to the user by a display apparatus with a display, or the like, for example. In the example illustrated in FIG. 12, an image indicating a current position of the calibration member 200 and information indicating the direction to move the calibration member 200 (a text of “move a little more to the right” and an arrow in a right direction) are presented to the user. The guidance information may be displayed as information including a specific distance of movement of the calibration member. For example, a text of “move another 30 cm to the right” may be displayed. Furthermore, when it is required to move the calibration member 200 in a diagonal direction, display for direct guidance in the diagonal direction may be performed, or display for stepwise guidance in the diagonal direction may be performed. For example, when the calibration member 200 is guided into a lower right direction, at first, only display for guidance in a right direction may be performed, and then, only display for guidance in a downward direction may be performed.

As illustrated in FIG. 13, an image indicating a current position of the calibration member 200 and a frame indicating the movement target point of the calibration member 200 may be presented to the user as the guidance information. In this case, a text that promotes a movement of the calibration member 200 into the frame (e.g., “move to be in the frame” etc.) may be displayed. The frame that is the movement target point of the calibration member 200 may have the same size as that of the calibration member 200, or may be slightly larger than the calibration member. In addition to or in place of the frame indicating the movement target point of the calibration member 200 as illustrated in FIG. 13, a frame indicating a movement target point of the marker 205 of the calibration member 200 may be presented to the user. When the calibration member 200 has a plurality of markers 205, a plurality of frames corresponding to the plurality of markers 205 may be displayed.

The display aspects of the guidance information described above are an example, and the guidance information may be outputted in another display aspect. Furthermore, when a plurality of types of display aspects can be realized, one of the plurality of display aspects may be selected and displayed. In this case, the display aspect may be selectable by the user. For example, the display aspect may be changed in accordance with the user's operation.

The guidance information may also be outputted not only as a visual indication (i.e., an image information), but also in another aspect. Specifically, the guidance information may be outputted as an audio information. The guidance information may be outputted as information including both the image information for display and the audio information for audio notification. When the guidance information includes the image information and the audio information, both of the display by the image information and the audio notification by the audio information may be performed at the same time, or only selected one (i.e., only the image indication, or only the audio notification) may be performed.

### (Technical Effect)

Next, a technical effect obtained by the calibration method according to the fifth example embodiment will be described.

As described in FIG. 10 to FIG. 13, in the calibration method according to the fifth example embodiment, the guidance information is outputted when the position of the calibration member 200 is improper. In this way, even when the position of the calibration member is not suitable for the calibration, it is possible to move the calibration member 200 to an appropriate position by using the guidance information. Consequently, even when the calibration member 200 cannot be placed in a proper position from the beginning, it is eventually possible to capture the images that are suitable for the calibration.

### Sixth Example Embodiment

A calibration method according to a sixth example embodiment will be described. The sixth example embodiment describes a specific example of the calibration member 200 used in the calibration method, and may be the same as the first to fifth example embodiments in other parts. For this reason, a part that is different from each of the example embodiments described above will be described in detail below, and a description of the other overlapping parts will be omitted as appropriate.

The calibration member 200 used in the calibration method according to the sixth example embodiment is configured such that at least one of brightness and chroma/saturation of the predetermined design is higher than a predetermined value. The “predetermined value” here is a threshold that is set to accurately detect the predetermined design, and may be calculated as a value that allows a desired detection accuracy to be realized by simulation or the like in advance, for example. The predetermined value may be separately set for each of the brightness and the chroma/saturation. That is, the predetermined value for brightness and the predetermined value for chroma/saturation may be different values.

Both of the brightness and the chroma/saturation are preferably greater than or equal to the respective predetermined values, but only one of them may be greater than or equal to the predetermined value thereof. The brightness of the calibration member in the images, however, is significantly influenced by an environmental parameter such as lighting. Therefore, if only one of the brightness and the chroma/saturation is set to the predetermined value, the chroma/saturation that is hardly influenced by the environmental parameter is desirably greater than or equal to the predetermined value.

Furthermore, the calibration member 200 is configured such that the predetermined design includes a plurality of hues. By that the predetermined design includes a plurality of hues, it is possible to perform the calibration by using a color information as well as the shape of the pattern of the predetermined design. If the predetermined design includes a plurality of hues, for example, “Colored Point Cloud Registration” that is an open CV may be used to perform alignment. Specifically, it is possible to perform alignment using a plurality of point clouds having the color information. Although the hues included in the predetermined design are not particularly limited, an appropriate hue (e.g., a hue that allows a higher detection accuracy) may be selected in accordance with an environment in which images are captured.

### (Technical Effect)

Next, a technical effect obtained by the calibration method according to the sixth example embodiment will be described.

In the calibration method according to the sixth example embodiment, the predetermined design of the calibration member 200 is set such that at least one of the brightness and the chroma/saturation is higher than the predetermined value and that the predetermined design includes a plurality of hues. In this way, it is possible to perform the calibration using the predetermined design with higher accuracy.

### Seventh Example Embodiment

A calibration method according to a seventh example embodiment will be described. The seventh example embodiment describes a specific example of the calibration member 200 used in the calibration method, and may be the same as the first to sixth example embodiments in other parts. For this reason, a part that is different from each of the example embodiments described above will be described in detail below, and a description of the other overlapping parts will be omitted as appropriate.

The calibration member 200 used in the calibration method according to the seventh example embodiment includes the marker 205 that is a plurality of two-dimensional codes. The two-dimensional code may be a two-dimensional code of a stack type or a two-dimensional code of a matrix type. An example of the two-dimensional code of the stack type includes a PDF417, a CODE49, and the like, but another two-dimensional code of the stack type can be applied as the marker 205 according to this example embodiment. An example the two-dimensional code of the matrix type includes a QR code (registered trademark), a DataMatrix, a VeriCode, an ArUko marker, and the like, but another two-dimensional code of the matrix type can also be applied as the marker 205 according to this example embodiment. The calibration member 200 may include a plurality of types of two-dimensional codes as the marker 205. In this case, the two-dimensional code of the stack type may be used in combination with the two-dimensional code of the matrix type.

According to the study of the inventors of this application, it has been found that the ArUko marker that is the two-dimensional code of the matrix type is suitable for the marker 205 of the calibration member 200. For this reason, the calibration member 200 preferably includes the ArUko marker, or a combination of the ArUko marker with another two-dimensional code, as the marker 205. Even when the marker 205 does not include the ArUko marker, a technical effect described later is correspondingly obtained.

### (Technical Effect)

Next, a technical effect obtained by the calibration method according to the seventh example embodiment will be described.

In the calibration method according to the seventh example embodiment, the calibration member 200 includes a plurality of two-dimensional codes. In this way, it is possible to improve the detection accuracy of the marker 205, and it is thus possible to perform the calibration more properly. Furthermore, since the two-dimensional code itself is allowed to have the information to be used for the calibration to (e.g., the information about the position, etc.), the calibration can be performed more easily. In addition, by arranging a plurality of two-dimensional codes, it is possible to detect the information about the position more accurately than when only one two-dimensional code is arranged.

### Eighth Example Embodiment

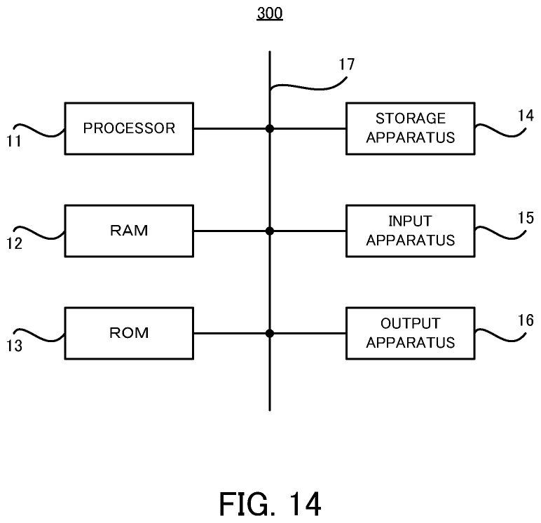

A calibration apparatus according to an eighth example embodiment will be described with reference to FIG. 14 to FIG. 16. The calibration apparatus according to the eighth example embodiment may be configured as an apparatus that is capable of performing the calibration methods according to the first to seventh example embodiments. Therefore, out of the operations performed by the calibration apparatus according to the eighth example embodiment, the operations described in the first to seventh example embodiments will not be described as appropriate.

### (Hardware Configuration)

First, with reference to FIG. 14, a hardware configuration of the calibration apparatus according to the eighth example embodiment will be described. FIG. 14 is a block diagram illustrating the hardware configuration of the calibration apparatus according to the eighth example embodiment.

As illustrated in FIG. 14, a calibration apparatus 300 according to the eighth example embodiment includes a processor 11, a RAM (Random Access Memory) 12, a ROM (Read Only Memory) 13, and a storage apparatus 14. The calibration apparatus 300 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium by using a not-illustrated recording medium reading apparatus. The processor 11 may obtain (i.e., may read) a computer program from a not-illustrated apparatus disposed outside the calibration apparatus 300, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for performing various processes related to the calibration is realized or implemented in the processor 11. An example of the processor 11 includes a CPU (Central Processing Unit), a GPU (Graphics Processing Unit), a FPGA (field-programmable gate array), a DSP (Demand-Side Platform), and an ASIC (Application Specific Integrated Circuit). The processor 11 may use one of the above examples, or may use a plurality of them in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the calibration apparatus 300. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the calibration apparatus 300. The input apparatus 15 may include, for example, at least one of a keyboard, a mouse, and a touch panel. The input apparatus 15 may be a dedicated controller (operation terminal). The input apparatus 15 may also include a terminal owned by the user (e.g., a smartphone or a tablet terminal, etc.). The input apparatus 15 may be an apparatus that allows an audio input including a microphone, for example.

The output apparatus 16 is an apparatus that outputs information about the calibration apparatus 300 to the outside. For example, the output apparatus 16 may be a display apparatus (e.g., a display) that is configured to display the information about the calibration apparatus 300. The display apparatus here may be a TV monitor, a personal computer monitor, a smartphone monitor, a tablet terminal monitor, or another portable terminal monitor. The display apparatus may be a large monitor or a digital signage installed in various facilities such as stores. The output apparatus 16 may be an apparatus that outputs the information in a format other than an image. For example, the output apparatus 16 may be a speaker that audio-outputs the information about the information processing apparatus 10.

### (Functional Configuration)

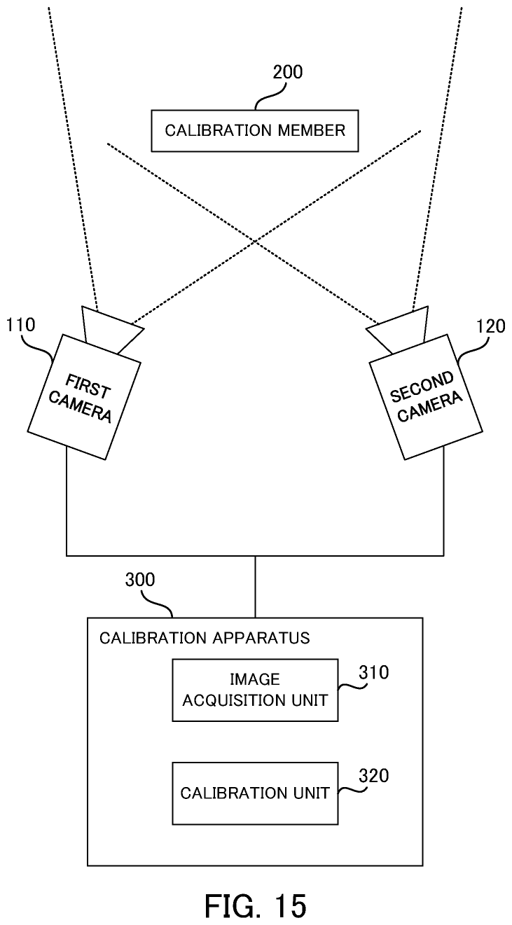

Next, with reference to FIG. 15, a functional configuration of the calibration apparatus 300 according to the eighth example embodiment will be described. FIG. 15 is a block diagram illustrating the functional configuration of the calibration apparatus according to the eighth example embodiment.

As illustrated in FIG. 15, the calibration apparatus 300 according to the eighth example embodiment is connected to the first camera 110 and the second camera 120 that are calibration targets. The calibration apparatus 300 includes, as processing blocks for realizing the function thereof, an image acquisition unit 310 and a calibration unit 320. Each of the image acquisition unit 310 and the calibration unit 320 may be realized or implemented by the processor 11 (see FIG. 1).

The image acquisition unit 310 is configured to obtain the images of the calibration member 200 captured by the first camera 110 and the images of the calibration member 200 captured by the second camera 120. The image acquisition unit 310 may include a storage unit (a memory) that stores the obtained images. For example, the image acquisition unit 310 may store a set of two images, one of which is an image captured by the first camera 110 and the other of which is an image captured by the second camera 120, wherein the images are captured at the same timing. The images obtained by the image acquisition unit 310 are configured to be outputted to the calibration unit 320.

The calibration unit 320 is configured to calibrate the first camera 110 and the second camera 120 on the basis of the image captured by the first camera 110 and the image captured by the second camera 120 that are obtained by the image acquisition unit 310. The calibration unit 320 is configured to control respective parameters of the first camera 110 and the second camera 120 such that the calibration can be performed. A detailed description of a specific calibration method is omitted here, because the techniques in the first to seventh example embodiments can be adopted to the method as appropriate.

### (Flow of Operation)

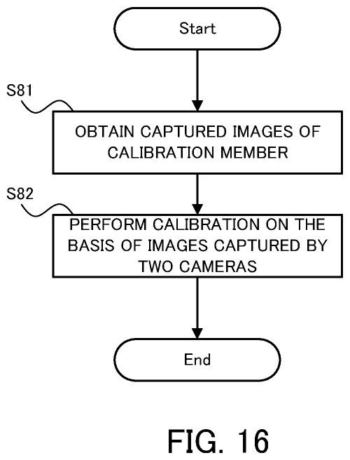

Next, with reference to FIG. 16, a flow of operation of the calibration apparatus 300 according to the eighth example embodiment will be described. FIG. 16 is a flowchart illustrating the flow of the operation of the calibration apparatus according to the eighth example embodiment.

As illustrated in FIG. 16, when the operation of the calibration apparatus 300 according to the first example embodiment is started, first, the image acquisition unit 310 obtains an image of the calibration member 200 captured by the first camera 110 and an image of the calibration member 200 captured by the second camera 120 (step S81). As in the third example embodiment and the fourth example embodiment described above, in the case of adopting such a configuration that images are captured repeatedly until the number of the images reaches a predetermined number, the image acquisition unit 310 may obtain the image captured by the first camera 110 and the image captured by the second camera 120 at each time when the imaging is performed by the first camera 110 and the second camera 120. Furthermore, the image acquisition unit 310 may function as a determination unit that determines whether or not the number of the images captured by the first camera 110 and the second camera 120 reaches a predetermined number.

Subsequently, the calibration unit 320 calibrates the first camera 110 and the second camera 120 on the basis of the image captured by the first camera 110 and the image captured by the second camera 120 that are obtained by the image acquisition unit 310 (step S82). As in the second example embodiment, in the case of adopting such a configuration that the first calibration process and the second calibration process are performed, the calibration unit 320 may include a first calibration unit that performs the first calibration process and a second calibration unit that performs the second calibration process.

Further, when employing a configuration for outputting the guidance information as in the fifth example embodiment, the calibration unit 320 may be configured to include a guidance information output unit for outputting the guidance information.

### (Technical Effect)

Next, a technical effect obtained by the calibration apparatus 300 according to the eighth example embodiment will be described.

As described in FIG. 14 to FIG. 16, in the calibration apparatus 300 according to the eighth example embodiment, the images of the calibration member 200 having the predetermined design and the marker 205 are captured, by which the first camera 110 and the second camera 120 (i.e., at least two cameras) are calibrated. In this way, by using the predetermined design and the marker 205 of the calibration member 200, it is possible to effectively reduce the “deviation” that occurs in the plurality of cameras, in a relatively easy manner.

### Ninth Example Embodiment

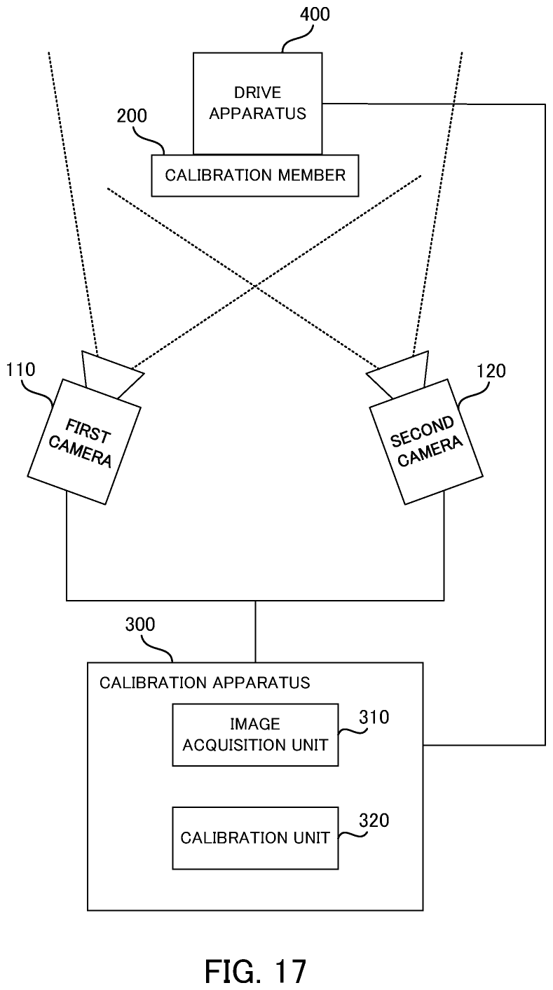

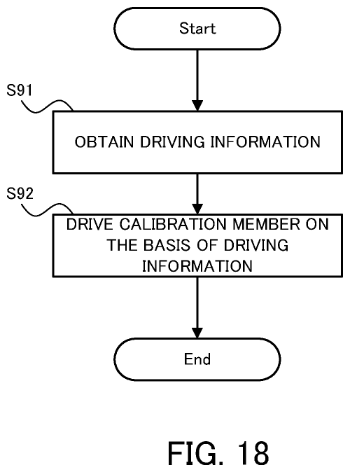

A calibration system according to a ninth example embodiment will be described with reference to FIG. 17 and FIG. 18. The calibration system according to the ninth example embodiment may be configured as a system that is capable of performing the calibration methods according to the first to seventh example embodiments. Therefore, out of the operations performed by the calibration system according to the ninth example embodiment, the operations described in the first to seventh example embodiments will not be described as appropriate. Furthermore, the calibration system according to the ninth example embodiment may have the same hardware configuration (FIG. 14) as that of the calibration apparatus 300 according to the eighth example embodiment described above. For this reason, a description of a part that overlaps the eighth example embodiment described above will be omitted as appropriate.

### (Functional Configuration)

First, a functional configuration of the calibration system according to the ninth example embodiment will be described with reference to FIG. 17. FIG. 17 is a block diagram illustrating the functional configuration of the calibration apparatus according to the ninth example embodiment.

As illustrated in FIG. 17, the calibration system according to the ninth example embodiment includes the first camera 110, the second camera 120, the calibration member 200, the calibration apparatus 300, and a drive apparatus 400. In the case of adopting such a configuration that the guidance information in the fifth example embodiment is outputted, the calibration system may include a display apparatus with a display, a speaker, or the like.

The drive apparatus 400 is configured to drive the calibration member 200. Specifically, the calibration member 200 is configured as an apparatus that is allowed to change the position or angle of the calibration member 200 with respect to the first camera 110 and the second camera 120. The drive apparatus 400 drives the calibration member 200 on the basis of information about the driving (hereinafter referred to as a “driving information” as appropriate) outputted from the calibration apparatus 300. That is, the operation of the drive apparatus 400 may be controlled by the calibration apparatus 300. The drive apparatus 400 may include, for example, various actuators or the like, but the configuration of the drive apparatus 400 is not particularly limited. When a particular support member is disposed in the vicinity of the subject of the first camera 110 and the second camera 120, the drive apparatus 400 may be integrally configured with the support member. For example, if the subject is a person who is seated in a chair, the drive apparatus 400 may be integrally configured with the chair. In this case, the calibration member 200 may be supported in a drivable manner by a headrest part of the chair, for example.

### (Operation of Drive Apparatus)

Next, with reference FIG. 18, the operation of the drive apparatus 400 provided in the calibration system according to the ninth example embodiment will be described in detail. FIG. 18 is a flowchart illustrating a flow of the operation of the drive apparatus of the calibration system according to the ninth example embodiment.

As illustrated in FIG. 18, the drive apparatus 400 according to the ninth example embodiment first obtains the driving information from the calibration apparatus 300 (step S91). The driving information may be outputted in the step S41 of the calibration process according to the fourth example embodiment (see FIG. 7), for example. That is, the driving information may be outputted as information for changing the position and angle of the calibration member 200 in a series of processing steps of capturing a plurality of times. Furthermore, the driving information may be outputted in the step S52 of the calibration method according to the fifth example embodiment (see FIG. 10 and FIG. 11). That is, the drive information may be the guidance information indicating the position and direction to move the calibration member 200.

Subsequently, the drive apparatus 400 drives the calibration member 200 on the basis of the obtained driving information (step S92). When the calibration member 200 is driven a plurality of times, the steps S91 and S92 may be repeatedly performed.

The drive apparatus 400 may also perform an operation programmed in advance, in addition to or in place of the driving based on the driving information. For example, the drive apparatus 400 may be set to drive the calibration member 200 at a predetermined timing such that the calibration member 200 is at the position and angle determined in accordance with the timing.

### (Technical Effect)

Next, a technical effect obtained by the calibration system according to the ninth example embodiment will be described.

As described in FIG. 17, in the calibration system according to the ninth example embodiment, the calibration member is automatically driven by the drive apparatus 400. In this way, it is possible to save time and labor of manually moving the calibration member 200. Furthermore, in comparison with the manual movement of the calibration member 200 manually, it is possible to realize a finer or more strict movement.

### Specific Application Examples

A description will be given to specific application examples of the calibration methods in the first to seventh example embodiments, the calibration apparatus in the eighth example embodiment, and the calibration system in the ninth example embodiment.

### (Three-Dimensional Facial Shape Measurement Apparatus)

Each of the above-described example embodiments is applicable to a three-dimensional facial shape measurement apparatus that measures a three-dimensional shape of a face. The three-dimensional facial shape measurement apparatus is configured to measure the three-dimensional shape of the face of a person who is a subject, by imaging the face of the person with two right and left cameras and synthesizing captured images. More specifically, the right camera captures an image of the right side of the face, and the left camera captures an image of the left side of the face. Then, a shape of the right side of the face created from the image of the right side of the face and a shape of the left side of the face created from the image of the left side of the face are synthesized to create a three-dimensional shape of the entire face of the person (e.g., including ears). The three-dimensional facial shape measurement apparatus may be an apparatus that captures an image while applying a sinusoidal pattern to the subject, and that performs a measurement using a sinusoidal grating shift method, for example.

In the three-dimensional facial shape measurement apparatus, as described above, a process of synthesizing the images captured by the two cameras is performed. Therefore, if there is a deviation between the two cameras, it is hardly possible to properly measure the three-dimensional shape of the face of a person. By applying the above-described example embodiments, however, the two cameras can be properly calibrated, and it is thus possible to properly measure the three-dimensional shape of the face of the person.

In an apparatus that is configured to capture three-dimensional images, as in the three-dimensional facial feature measurement apparatus, it is also possible to perform the calibration using the three-dimensional images, as a calibration method in another example embodiment. That is, when the first camera 110 and the second camera 120 are configured as cameras that are capable of capturing the three-dimensional images (e.g., a 3D scanner or a range finder, etc.), the first camera 110 and the second camera 120 may be calibrated by using the three-dimensional images of the calibration member 200. Such calibration will be described in detail below.

### (Calibration Using Three-Dimensional Images)

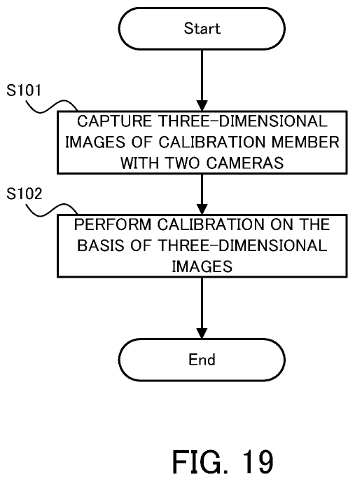

With reference to FIG. 19, a flow of operation of the calibration using the three-dimensional images will be described. FIG. 19 is a flowchart illustrating the flow of the operation of the calibration using the three-dimensional images.

As illustrated in FIG. 19, in the calibration method using the three-dimensional images, the first camera 110 and the second camera 120 respectively capture the three-dimensional images of the calibration member 200 (step S101). The three-dimensional images of the calibration member 200 are captured to have the predetermined design and the marker 205. When such a configuration that allows a predetermined light pattern, such as a sinusoidal pattern, to be projected (e.g., a projector, etc.) is provided, the calibration member 200 may be imaged with the predetermined light pattern projected thereon. In this case, for example, a reflection member is attached to the calibration member 200 as the marker 205, and a reflected light when the pattern is applied (i.e., a light reflected by the reflection member) may be used to specify the position and direction of the reflection member that is the marker 205.

Subsequently, the first camera 110 and the second camera 120 are calibrated on the basis of the three-dimensional images of the calibration member 200 (step S102).

That is, the calibration is performed by using the predetermined design and the marker 205 in the three-dimensional images. More specifically, the positions of the first camera 110 and the second camera 120 may be adjusted such that the captured three-dimensional images coincide between the first camera 110 and the second camera 120.

As described above, according to the calibration method using the three-dimensional images, it is possible to properly calibrate the cameras that are configured to capture the three-dimensional images on the basis of the predetermined design and the marker 205 in the three-dimensional images.

A processing method in which a program for allowing the configuration in each of the example embodiments to operate to realize the functions of each example embodiment is recorded on a recording medium, and in which the program recorded on the recording medium is read as a code and executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes processing alone, but also the program that operates on an OS and executes processing in cooperation with the functions of expansion boards and another software, is also included in the scope of each of the example embodiments.

This disclosure is not limited to the examples described above and is allowed to be changed, if desired, without departing from the essence or spirit of this disclosure which can be read from the claims and the entire specification. A calibration method, a calibration apparatus, a calibration system, a computer program, and a recording medium with such changes are also intended to be within the technical scope of this disclosure.

### <Supplementary Notes>

The example embodiments described above may be further described as, but not limited to, the following Supplementary Notes below.

### (Supplementary Note 1)

A calibration method described in Supplementary Note 1 is a calibration method including: imaging a member having a predetermined design in which a pattern varies depending on a position on a member surface and a marker disposed at a predetermined position, with at least two cameras; and performing calibration of the at least two cameras by using an image of the member captured by the at least two cameras.

### (Supplementary Note 2)

A calibration method described in Supplementary Note 2 is the calibration method described in Supplementary Note 1, wherein performed as the calibration are, a first calibration based on the marker in the image of the member, and a second calibration based on the pattern of the predetermined design in the image of the member.

### (Supplementary Note 3)

A calibration method described in Supplementary Note 3 is the calibration method described in Supplementary Note 1 or 2, wherein the member is imaged a plurality of times with the at least two cameras, and the calibration of the at least two cameras is performed by using a plurality of images of the member.

### (Supplementary Note 4)

A calibration method described in Supplementary Note 4 is the calibration method described in Supplementary Note 3, wherein the member is imaged a plurality of times at different positions or angles.

### (Supplementary Note 5)

A calibration method described in Supplementary Note 5 is the calibration method described in any one of Supplementary Notes 1 to 4, wherein information indicating a position or direction to move the member is outputted such that the member is at a position suitable for capturing the image of the member.

### (Supplementary Note 6)

A calibration method described in Supplementary Note 6 is the calibration method described in any one of Supplementary Notes 1 to 5, wherein the predetermined design has at least one of brightness and chroma/saturation that is higher than a predetermined value, and the predetermined design includes a plurality of hues, and the marker is a plurality of two-dimensional codes.

### (Supplementary Note 7)

A calibration method described in Supplementary Note 7 is the calibration method described in any one of Supplementary Notes 1 to 6, wherein a three-dimensional image of the member is captured with the at least two cameras, and the calibration of the at least two cameras is performed by using the three-dimensional image.

### (Supplementary Note 8)

A calibration apparatus described in Supplementary Note 8 is a calibration apparatus including: an acquisition unit that obtains an image captured by imaging a member having a predetermined design in which a pattern varies depending on a position on a member surface and a marker disposed at a predetermined position, with at least two cameras; and a calibration unit that performs calibration of the at least two cameras by using the image of the member captured by the at least two cameras.

### (Supplementary Note 9)

A calibration system described in Supplementary Note 9 is a calibration system including: a member having a predetermined design in which a pattern varies depending on a position on a member surface and a marker disposed at a predetermined position; a drive apparatus that drives the member to change a position or angle of the member with respect to at least two cameras; and a calibration apparatus that performs calibration of the at least two cameras by using an image of the member imaged by the at least two cameras.

### (Supplementary Note 10)

A computer program described in Supplementary Note 10 is a computer program that operates a computer: to image a member having a predetermined design in which a pattern varies depending on a position on a member surface and a marker disposed at a predetermined position, with at least two cameras; and to perform calibration of the at least two cameras by using an image of the member captured by the at least two cameras.

### (Supplementary Note 11)

A recording medium described in Supplementary Note 11 is a recording medium on which the computer program described in Supplementary Note 10 is recorded.

To the extent permitted by law, this application claims priority to Japanese Patent Application No. 2020-198243, filed on Nov. 30, 2020, the entire disclosure of which is hereby incorporated by reference. Furthermore, to the extent permitted by law, all publications and papers described herein are incorporated herein by reference.

### DESCRIPTION OF REFERENCE CODES

110 First camera
120 Second camera
200 Calibration member
205 Marker
300 Calibration apparatus
310 Image acquisition unit
320 Calibration unit
400 Drive apparatus

What is claimed is:

1. A calibration method comprising:
imaging a member having a predetermined design in which a pattern varies depending on a position on a member surface and a marker disposed at a predetermined position, with at least two cameras; and
performing calibration of the at least two cameras by using an image of the member captured by the at least two cameras.

2. The calibration method according to claim 1, wherein performed as the calibration are,
a first calibration based on the marker in the image of the member, and
a second calibration based on the pattern of the predetermined design in the image of the member.

3. The calibration method according to claim 1, wherein
the member is imaged a plurality of times with the at least two cameras, and
the calibration of the at least two cameras is performed by using a plurality of images of the member.

4. The calibration method according to claim 3, wherein the member is imaged a plurality of times at different positions or angles.

5. The calibration method according to claim 1, wherein information indicating a position or direction to move the member is outputted such that the member is at a position suitable for capturing the image of the member.

6. The calibration method according to claim 1, wherein
the predetermined design has at least one of brightness and chroma/saturation that is higher than a predetermined value, and the predetermined design includes a plurality of hues, and
the marker is a plurality of two-dimensional codes.

7. The calibration method according to claim 1, wherein
a three-dimensional image of the member is captured with the at least two cameras, and
the calibration of the at least two cameras is performed by using the three-dimensional image.

8. A calibration apparatus comprising:
at least one memory that is configured to store instructions; and
at least one first processor that is configured to execute the instructions to
obtain an image captured by imaging a member having a predetermined design in which a pattern varies depending on a position on a member surface and a marker disposed at a predetermined position, with at least two cameras; and
perform calibration of the at least two cameras by using the image of the member captured by the at least two cameras.

9. (canceled)

10. A non-transitory recording medium on which a computer program that allows a computer to execute a calibration method is recorded, the calibration method including:
imaging a member having a predetermined design in which a pattern varies depending on a position on a member surface and a marker disposed at a predetermined position, with at least two cameras; and
performing calibration of the at least two cameras by using an image of the member captured by the at least two cameras.
